(19) United States
(12) Patent Application Publication
(10) Pub. No.: US 2007/0170791 A1
(43) Pub. Date: Jul. 26, 2007

(54) Magnet wheel alternator/ generator electricity producing wheel

(76) Inventor: Michael Steven Hargett, Albany, OR (US)

Correspondence Address: MICHAEL STEVEN HARGETT, 2560 16th AVE. S.E., ALBANY, OR, 97322, US

(21) Appl. No.: 11/642,565

(22) Filed: Dec. 21, 2006

Related U.S. Application Data
(60) Provisional application No. 60/761,210, filed on Jan. 24, 2006.
(60) Provisional application No. 60/808,566, filed on May 26, 2006.

(51) Int. Cl. H02K 7/18; B62J 6/12; F03G 7/08

(52) U.S. Cl. 310/67 A; 290/1 R; 310/75 C

(57) ABSTRACT

The Magnet Wheel Alternator/Generator Electricity Producing Wheel is applicable to an Electric Vehicle. The Electric Vehicle is mainly the same as any other Vehicle used by people to transport people as well as goods. These Vehicles are in the form as Cars, Pick Up Trucks and Tractor-Trailer Rigs. However, any wheel or revolving motion device can be used to apply this Invention. The standard means of comprising these Vehicles are they all have rubber tires and metal wheels. These metal wheels are mounted inside of the Rubber tire. In this application a standard automotive tire and wheel is used. This automotive tire and wheel consists of 2 parts in most cases. There is the outer rubber tire and the inner wheel made mostly common made of metal. The tire and wheel commonly is in the shape of a circle. The metal wheel fits inside of the rubber tire. These tires for vehicles are commonly used in vehicles for the means of transportation of people and goods. The standard power source for these Vehicles is Fossil Fuels. The Engines are combustion engines and require Gasoline as a fuel, which is a derivative of crude oil. This Invention applies to the Electric Vehicle which is a safer and more friendly means of transportation for the enviroment and national secuity. This Invention address's environmental concerns, as well as foreign supplies of crude oil issues. The monies made from the sale of the crude oil are used in many ways that are detrimental to the well being of the United States. A few ways are to supply Terrorist with buying power and the possible means to attack us.

This Invention relates to the Electric Vehicle development as a means to create usable electricity in the Electric Vehicle operation. This Invention is comprised of a standard wheel and tire, which are mounted onto a standard vehicle's that are commonly a pick up truck, a passenger vehicle or a tractor-trailer, or other vehicles that are in use.

All of these vehicles are used to transport people or goods. The inner working's of the Invention is mounted to the inside of the metal wheel part of a standard vehicle wheel. The Invention in essence is a means to create electricity when the vehicle is in operation being driven. The rotation of the wheels activates the repelling action of the Magnets that are attached to a Generator or and Alternator wheel. This Invention has a broader capability also of adapting any other device in the means to create electricity for the powering of the Electric Vehicle. The Invention referances and Alternator and Generator in this application. The Alternator/Generator produces electricity for the operation of the Electric Vehicle. The Generator in this application is for producing electricity at high speeds. The Alternator in this application produces electricity at slow speeds. This Invention can be applied to as many wheels that are in operation in the vehicle.

### FIELD OF INVENTION

This Invention relates to a vehicle wheel that uses Magnets to help overcome physical, mechanical, thermodynamic drags. The Magentic drag that is created is in the form of electricity. This invention also incorporates the use of a vehicle Alternator or Generator, to electricity in addtion to the repelling Magnets. Thus converting a standard vehicle wheel into and electricity producing device. This invention then is applied to an Electric Vehicle to supply electricity to the motor and the batteries for the means as power in operation.

### DESCRIPTION OF PRIOR ART AND CROSS REFERENCED APPLICATIONS AND PATENTS

There is no Prior Art to report. There are 0 Patents as Prior Art. There is no other Prior Art to report to my knowledge from any other sources connected to this invention. The only Patents to report are 2 Provisionals Granted to Michael Steven Hargett. The Patents numbers are U.S. Pat. Nos. 60/761,210 and 60/808,566

### DESCRIPTION OF THE DRAWING

FIG. (1)

Number 1, shows a standard automobile rubber tire. Number 2, shows the pyramid magnets as gears, which are fastened to the inside of the metal wheel rim. These pyramid shapes of the magents can actually be any shape that would be desirable in the production of the electricity. Number 3, shows the inner magnet wheel that the alternator or generator attaches to. The alternator and or generator are not shown in the drawing for simplication in viewing the drawing. The hex openning in the center of the smaller inner gear in the magnet wheel. This hex openning is where the electricity producing device would be attached. The alternator, generator or other type of electricity producing device, would then be attached and placed to the appropriate distance from the other magnet wheel pyramids. This placement is made so that they do not touch inn the rotation of the wheel as it is being driven.

### PREFFERED EMBODIMENT PAGE 1

The Electric Vehicle for many years has been a costly means of travel. With the introduction of The Magnet Wheel Alternator/Generator Electricity Producing Invention this has been overcome. The forces that are considered negatives in physics such as physical, mechanical, and thermodynamic drags. The use of Magnets that are repelling one another and that do not touch eliminates these drags concerning gears touching. The drag that is produced is magnetic drag, which is in the form of electricity. This electricity is used by the Electric Vehicle in forms such as recharging the Batteries or sending the electricity to the vehicles motor. As you can see in the drawing's that the Magnets do not touch.

The Magnets not touching and using the same poles of the Magnets such as north to north or south to south. As the Electric Vehicle begins to be driven and the wheels turn the Magnets that are repelling each other also turn from the magnetic field that are forced upon each other. Thus the wheel turns and the Alternator/Generator wheel turns. As the result of the Magnets repelling each other in the turning motion electricity is produced.

The result is that the Alternator or Generator wheel turns and produces electricity. The Magnets that are repelling each other as the vehicle is being driven creates the Magnet Wheel Motor. Alternators at slow speeds and Generators at high speeds creates electricity for the Electric Vehicle at slow and high speeds. That electricity that is produced from the motors is sent to the batteries for recharging or to the electric motor or both.

### PREFERRED EMBODIMENT PAGE 2

The Magnet Wheel Alternator Electricity Producing Wheel is the Invention that will allow the Electric Vehicle to be traveled further than ever thought possible. This Invention uses the motion of the vehicles wheels as it is being driven to produce electricity for the battery system and the electric motor of the vehicle. By using magnets and taking into account that the magnets repell one another and can produce electricity, at that same time eliminating drags that are negitives that restrain vehicle. The Magnet Wheels work by placing the magnets together with the same poles facing one another as the same poles face one another. When the wheels are turning they are producing electricity. This electricity is produced by electricity producing devices and the magnet repelling field.

By achieving this form electric power production, the electric vehicle can use the electricity that is produced for its on propulsion needs. The production of electricity is sent to the electric vehicles motor for powering the vehicle as well to the batteries to recharge them or lessen the drain on them.

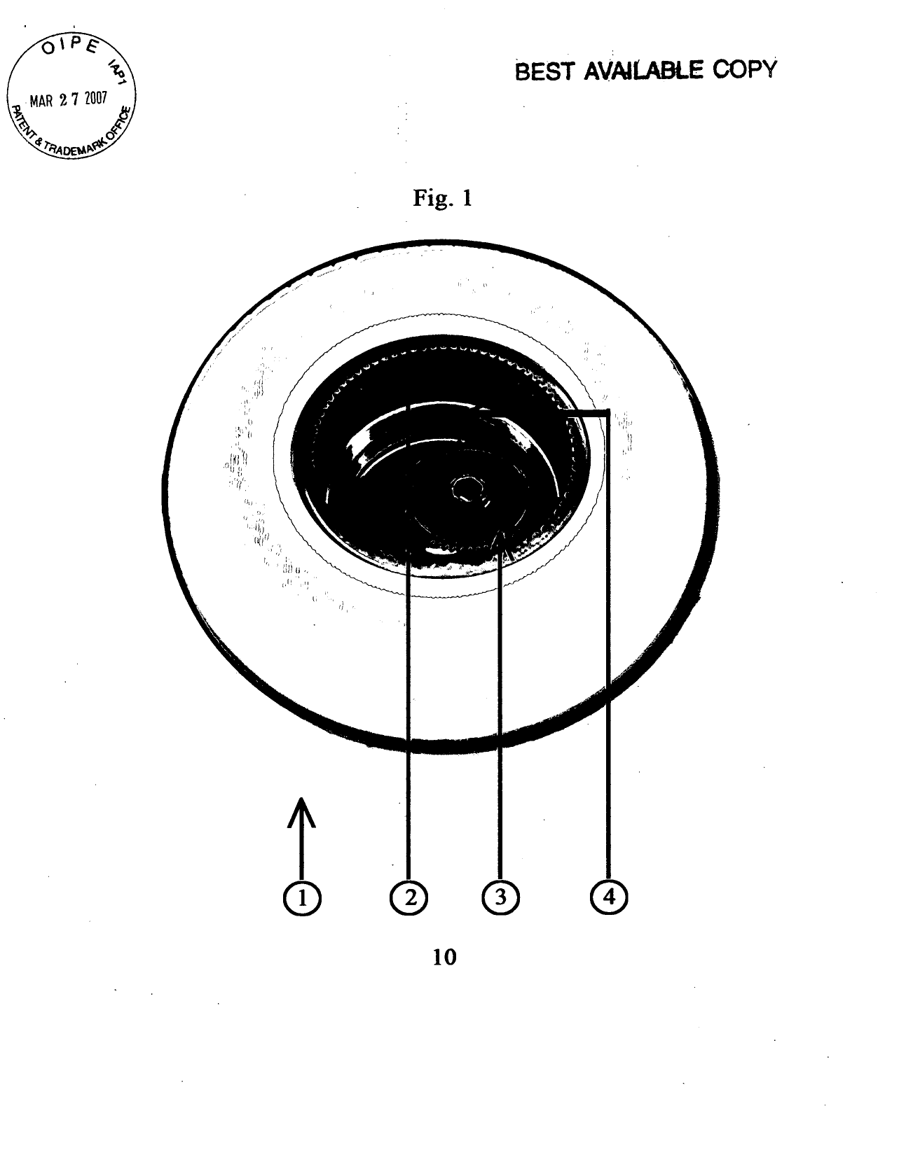

This is how the Invention works and is constructed. Taking and standard automotive wheel and rubber tire FIG. 1 #1.

Attaching the magnet pyramids FIG. 1 #2 to the inside wall of the metal rim of the wheel. Place the same poles to face inward on the inside wheel wall. FIG. 1 #3 would also have magnet pyramids attached to out side of the inner smaller wheel. These pyramid magnets would face the pyramid magnets that are on the inside wheel wall, FIG. 1 #2. The smaller inner magnet wheel would be placed so that the pyramid magnets do not touch, FIG. 1 #3. The electricity producing device would then be attached to the smaller inner magnet wheel by the hex openning, FIG. 1 # 3. The electricity producing device would then be attached to the Electric Vehicles axle or frame. By attaching the electricity producing device to the frame or axle it would hold the Magnet Wheel Motor in place as the vehicle is being driven.

1. What is claimed is the use of Magnets placed together facing one another. Facing same poles north to north or south to south, they repell one another. The repelling action of the Magnets creates electricity when the wheel is in rotation and eliminates drags.

2. By placing the Magnets on a standard vehicle alternator or generator, or other electricity producing devices.
These electricity producing devices will produce electricity when the vehicles wheel are in rotation. In both cases the rotation of the vehicles wheels are caused from the vehicles movement, or by a mechanical means such as a gear. In most cases from wheels of the as it is being driven. Both repelling poles in the Magnets use in the Alternator or Generator or any other electricity producing device which can be adapted to the Invention, will create the electricity producing.
